(19) United States
(12) Patent Application Publication
(10) Pub. No.: US 2009/0122816 A1
(43) Pub. Date: May 14, 2009

(54) Rapidly and electronically broadly tunable IR laser source

(75) Inventors: Gregory J. Wagner, Westminister, CO (US); Timothy J. Carrig, Lafayette, CO (US); Wayne S. Pelouch, McKinnie, TX (US)

Correspondence Address: MCDERMOTT WILL & EMERY LLP, 18191 VON KARMAN AVE., SUITE 500, IRVINE, CA, 92612-7108, US

(73) Assignee: Lockheed Martin Coherent Technologies, Inc., Louisville, CO (US)

(21) Appl. No.: 11/387,109

(22) Filed: Mar. 22, 2006

Related U.S. Application Data
(60) Provisional application No. 60/719,667, filed on Sep. 22, 2005.

(51) Int. Cl. H01S 3/10

(52) U.S. Cl. 372/20

(57) ABSTRACT

A laser source producing rapidly tunable emission in the infrared part of the electromagnetic spectrum is disclosed. The source incorporates a Cr²⁺ laser and an electrically operated tuning element to enable rapid switching of emission wavelength. The use of the source in conjunction with frequency converters, in particular optical parametric oscillators, permits covering a wider spectral range. In such cases the frequency converter output wavelength can be rapidly tuned by electrically tuning the laser. The laser source has uses in many applications of practical interest and is particularly well suited as the transmitter in remote sensing system or as a source in directed energy systems.

### GOVERNMENT LICENSE RIGHTS

The U.S. Government has rights in this invention pursuant to Air Force Laboratory contract F29601-02-C-0112.

### BACKGROUND OF THE INVENTION

1. Field of the Invention

The present invention is in the field of coherent light sources and, more specifically, in the field of tunable coherent light sources using tunable lasers, alone or in conjunction with non-linear optical frequency conversion elements.

2. Background

Infrared light sources operating in the spectral range 2-14 μm are useful for many applications of practical importance. For purposes of this disclosure this spectral range is hereinafter referred to as the infrared or “IR”, even though shorter and longer wavelengths are technically also part of the infrared spectrum. The need for these devices, as opposed to, for example, shorter wavelengths, is driven by several factors. One is that atmospheric transmission of infrared light is generally good, with superior transmission through smoke, rain, clouds, and other obscurants that may be present, compared with shorter wavelengths. A second reason is that this spectral region is predominantly where many chemicals and hard targets have wavelength dependent absorption or reflection features and other signatures that can be probed using light, for example by using differential absorption lidar (DIAL) or differential absorption spectroscopy systems, active (“active” refers to employing a light source for illumination as opposed to a “passive” sensor that uses ambient light) multi-spectral imaging systems, and passive or hybrid active-passive hyper-spectral imaging systems. A third reason is that hot objects produce significant thermal radiation in the IR and use of a light source in the IR can consequently be used to mimic the thermal signature of a hot object such as an airplane.

The lack of suitable tunable laser sources operating in the IR spectral region has been problematic for many years and has limited the practical deployment of important systems, especially defense related systems. One example is the use of an IR light source to divert heat-seeking missiles from aircraft using a technique referred to as directed infrared countermeasures (DIRCM or IRCM). Another example is the provision of an IR source in a DIAL sensor that can be rapidly switched between many wavelengths (for example tens or hundreds) to probe for the presence of chemical or biological agents. A third example is the use of an active multi-spectral imager to distinguish dissimilar materials such as metallic objects from nonmetallic objects (ex. distinguishing tanks from foliage). A number of non-military applications also have the same light source needs. One example is spectroscopic systems that monitor industrial pollutants and chemical leaks, where the source is part of an in-situ sensor or a remote sensing system such as a DIAL sensor. Another example relates to metrology, such as the use of a source at the appropriate wavelengths to characterize, for instance, the reflectivity of a surface as a function of wavelength.

Common multi-wavelength IR sources like CO₂ lasers are typically restricted to operation at discrete wavelengths over very limited bands, such as near 9-11 microns, whereas most solid-state lasers either operate at shorter wavelengths (including many in the 0.7-2 micron range) and/or have narrow or very narrow tuning ranges. Examples are broadly tunable near-IR solid-state lasers such as the Ti:Sapphire and Cr³⁺:LiSAF lasers that operate in the 0.7-1 micron range, narrowly tunable lasers such as the Yb:YAG and Er:YAG lasers that operate around the 1 and 1.6 micron ranges, respectively, and very narrowly tunable lasers such as the Nd:YAG laser that operates around 1 micron. A second class of sources is semiconductor diode and semiconductor quantum cascade lasers that can be fabricated at a relatively wide range of largely fixed or narrowly tunable wavelengths. However, when such sources are configured to tune over narrow spectral regions they typically have low brightness and output very low optical powers, up to ˜1 W, making them unsuitable for many of the applications noted above. Because of this relative lack of direct, broadly tunable laser sources in the IR spectrum, optical parametric oscillators (OPOs) and other non-linear frequency conversion devices have been developed to convert the output of shorter, fixed wavelength sources to tunable, longer wavelength output. A limitation to the use of OPOs, however, is that often the tuning speed of the source is slower than desired. In a typical OPO the device is pumped with a fixed frequency source and wavelength tuning is accomplished by physically rotating the OPO crystal. Since this requires mechanical actuators and precise motion control, the result is often slow tuning speeds. Additionally, concerns over reliability and wear of the mechanical components limit the operational lifetime and ruggedness of the OPO device. Other OPOs, especially those that employ quasi-phase-matched nonlinear materials, are often tuned by changing the temperature of the OPO crystal. Such thermal tuning is also too slow for many applications, although the devices can be quite rugged.

A partial solution to the problem of wide tuning and moderate to high power output has been overcome with the development of Cr²⁺ solid-state lasers in recent years (see for example R. H. Page et al, “Recent developments in Cr²⁺-doped II-VI compound lasers ”, OSA TOPS on Advanced Solid-State Lasers, pp. 130, 1996; G. J. Wagner et al., “Continuous-wave, broadly tunable Cr²⁺:ZnSe laser” Optics Letters, 24, pp. 19, 1999; W. J. Alford et al., “High-power and Q-switched Cr:ZnSe lasers,” OSA Trends in Optics and Photonics Vol. 83, Advanced Solid-State Photonics, J. J. Zayhowski, ed., (Optical Society of America, Washington D.C., 2003), pp. 13-17; and U.S. Pat. No. 5,541,948 to Krupke et al.; all hereby incorporated by reference). These lasers are highly attractive particularly because of their high quantum efficiency and their wide emission bands that offer wide wavelength tunability. However, as implemented to date tunable versions of these lasers suffer from the same limitations as discussed above in the context of OPOs, namely slow tuning requiring some form of mechanical movement, such as rotating a mirror or grating. Scanning such sources over a wide range of wavelengths or jumping between specific wavelengths can become very time consuming, limiting the usefulness of the source.

A need remains in the art for a broadly and rapidly tunable IR laser source that does not employ moving mechanical parts or slow thermal tuning.

### SUMMARY OF THE INVENTION

An object of the present invention is to provide a broadly and rapidly electronically tunable IR laser source. The disclosed invention uses widely tunable Cr²⁺ lasers in conjunction with electrical tuning to rapidly change wavelengths. The combination of IR emission, wide tunability of the laser, and use of electrical means for fast tuning leads to clear advantages over alternative methods of the prior art and in fact provides the first practical solution to problems that have lacked solutions for many years. In addition to the extensive and fast tuning offered by the laser itself, the use of non-linear frequency conversion devices, in particular pump-tuned OPOs, permit a high degree of extension of the tuning range while retaining the fast tunability. With suitably chosen OPOs the tuning range may cover substantially the entire infrared wavelength range from 2-14 μm. When OPOs are used in conjunction with the laser, the tuning is most beneficially done by tuning the pump wavelength electrically, rather than directly tuning the OPO.

### BRIEF DESCRIPTION OF THE DRAWINGS

FIG. 1 shows a tunable laser source in accordance with the disclosed invention.

FIG. 2 shows a tuning curve achieved by the tunable laser source of FIG. 1 through the use of an AOTF tuning element.

FIG. 3 shows the tunable laser source of FIG. 1 used in conjunction with an optical parametric oscillator to increase the source tuning range.

FIG. 4 shows an intra-cavity configuration where the OPO is placed inside the tunable laser cavity.

FIG. 5 shows the laser in a Master Oscillator Power Amplifier (MOPA) configuration.

FIG. 6 shows a system architecture using two parallel lasers and OPOs to increase the tuning range.

FIG. 7 shows the tunable laser source of FIG. 1 used in conjunction with a difference frequency generator to increase the source tuning range.

### DETAILED DESCRIPTION OF THE PREFERRED EMBODIMENTS

In the following description the term “laser source” will be used to denote either a laser by itself or a laser used in conjunction with a non-linear optical frequency conversion device. Which case the term applies to at any given instance is apparent to those skilled in the art from the context in which it is used.

### 1. Tunable Laser Embodiment

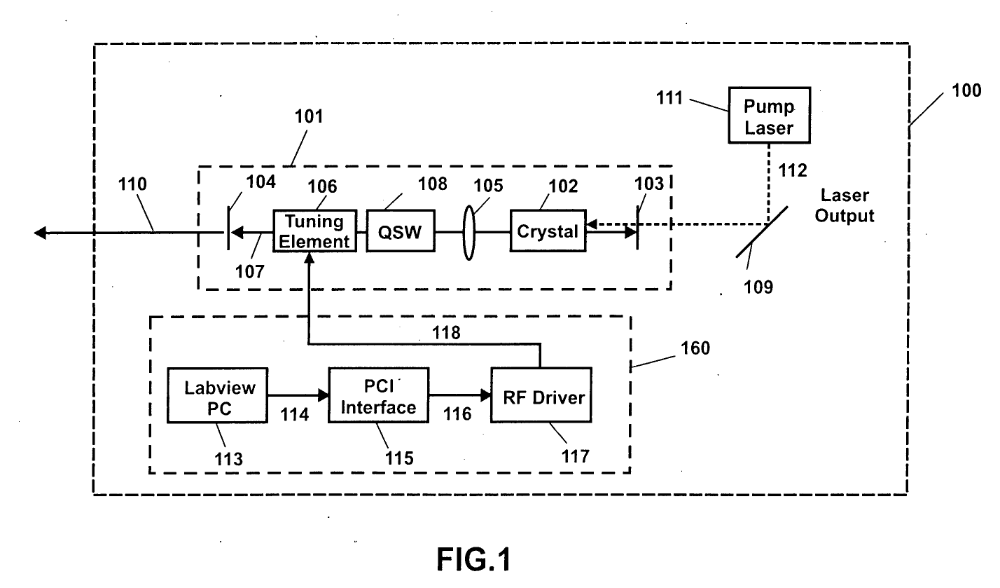

A preferred embodiment of a tunable laser source 100 is shown in FIG. 1. In FIG. 1 numeral 101 denotes the tunable laser portion, which comprises several parts. A laser gain element 102 of Cr²⁺ doped material is placed between a partially reflective output coupler 104 and a reflective optic 103. The reflectivity of output coupler 104 is selected for desired laser performance and may have a reflectivity in the range of 20-99% at the laser wavelength and a corresponding transmission in the range of 80-1%. The final choice of mirror reflectivity is a laser design issue and the associated trade-offs are well understood by those knowledgeable in the art. Reflective optic 103 normally has a very high reflectivity, for example 99.9% or greater at the laser wavelength and a low reflectivity, for example <1%, at the pump wavelength. A low transmission loss lens 105 is disposed within the laser cavity formed by mirrors 103 and 104 and has a focal length selected to produce a stable laser mode within the cavity with a desired laser mode size. The illustrated lens is not essential to the design as there are many other ways known in the art to produce a laser cavity mode of the appropriate size, such as using curved end-mirrors or relying upon a thermally induced lens in the Cr²⁺ doped material. Cavity designs may also employ non-normal incidence mirrors in order to fold resonators, as well as for permitting pumping through non-normal incidence optics. While the described embodiment employs a standing-wave linear cavity, the laser may alternatively employ a traveling-wave ring cavity. Also disposed within the laser cavity is a tuning element 106 that is electrically tunable. This tuning element is preferably an acousto-optic tunable filter (AOTF), but may also comprise any other device that permits the laser wavelength to be tuned rapidly through the control of an electrical voltage or current. Another example of a suitable device would be an electro-optic Lyot filter. Yet another example would be a liquid crystal modulator.

The tunable laser 101 is pumped by a pump laser 111 that outputs a beam 112, which is reflected from mirror 109, is transmitted through reflective optic 103, and is absorbed in laser crystal 102. The pump beam 112 is illustrated as a dashed line separated from the laser output beam 110 for clarity only. In practice the two beams would be substantially overlapping spatially in the laser gain element. Optical isolators (not shown) may also be used to reduce feedback into the pump laser. Alternatively, laser configurations that do not require normal incidence optics may also be designed in cases where such feedback is a concern. Pump beam 112 may also be coupled into laser gain element 102 without passing through a cavity mirror, for example via non-collinear pumping through the end face of laser gain element 102 or pumping through the side of laser gain element 102.

Absorption of pump light 112 in the laser gain element 102 causes a population inversion to be generated and laser action takes place wherein the laser beam resonates between the output coupler 104 and the reflective optic 103, in the process traveling through tuning element 106. The tuning element acts as a narrowband filter and only efficiently transmits a narrow band of wavelengths or frequencies. Furthermore the center wavelength or frequency of this spectral filtering device can be altered through electrical means. In the case where the tuning element 106 comprises an AOTF, wavelength control is effected through a tuning control subsystem 160. In the preferred embodiment subsystem 160 incorporates a programmable device 113, for example a PC operating LabVIEW® software that outputs a control signal 114 to a computer interface 115, such as a PCI interface. Control signal 114 and consequently the output signal 116 from interface 115 contains an encoded signal used to generate a specific RF frequency in RF driver 117. RF driver 117 in turn generates the RF signal and drives AOTF 106 at an RF frequency through signal 118, such that the laser cavity has a low loss at a specific laser wavelength. As RF frequency signal 118 is changed, the AOTF bandpass center wavelength and therefore the laser output wavelength changes. The correspondence between encoded control signal and laser wavelength is most easily determined experimentally, for example by generating a lookup table in the PC wherein a set of control signal values correspond to measured laser wavelength values. In experiments carried out by the inventors the control signal comprised a 30 bit binary word to encode the desired laser frequency. A very attractive feature of the bulk (as opposed to integrated optics) AOTF used in this invention is that they can be designed such that the angle of the beam exiting the device can be made independent of the bandpass center wavelength of the AOTF. Without this angular independence additional angular compensating means (such as a tilting mirror) would have to be included to keep the laser cavity aligned. Use of such compensating means would obviously be detrimental to the purpose of fully electrical and rapid tuning. A variation of the disclosed tuning method has been disclosed by Wada et al. (“Electronically tuned picosecond Ti sapphire laser”, RIKEN Review No. 49, pp. 7, 2002) to produce mode-locked pulses in a short wavelength Ti:Sapphire laser. However, that laser used a dispersive AOTF where the angle was altered as the laser was tuned, resulting in the need to insert additional compensating elements into the cavity to prevent the angular deflection of the beam from limiting the tunability. Use of such additional devices is undesirable as it adds complexity and increases the mechanical stability requirements of the laser source. AOTFs in integrated optics form have been utilized for tuning purposes, such as in devices disclosed in U.S. Pat. No. 6,333,941 to Hung and U.S. Pat. No. 6,847,662 to Bouda et al. However, the purpose of those devices was to tune low power lasers for fiber optic communications in the shorter wavelength telecom spectral range. Integrated optical devices are constructed to propagate very small beams having typical beam diameters on the order of 10 μm. The small size limits the average optical power that can propagate before optical damage occurs, making them poorly suited to use in the IR lasers disclosed here. A second, frequently far more limiting factor, is that the insertion loss is far higher than can be tolerated for the disclosed lasers to be efficient. Great care must be taken in constructing lasers that have low loss in order that the efficiency of the laser is high. Devices inserted into Cr:ZnSe lasers generally should have losses of no more than several percent to maximize laser efficiency. This is generally far less of a concern in telecommunications systems where integrated optics devices having losses of several tens of percent are frequently acceptable.

The result of the design in FIG. 1 is that the pump laser beam 112 pumps the laser gain element 102, the tuning element 106 controls the wavelength based on the control signal 114, producing a laser beam 107 that circulates between optics 103 and 104, a fraction of which is coupled out through output coupler 104 as output beam 110. The wavelength of output beam 110 can consequently be tuned through a change in the control signal 114.

A number of other devices can be utilized to increase the versatility of the laser source depending in part on the pump laser 111. The primary requirement on the pump laser is that it produces a laser beam at a wavelength that is absorbed in the laser gain element 102 with a mode quality such that the pump beam can be confined substantially within the laser mode size throughout the laser gain element. An attractive feature of Cr²⁺ laser materials is that the absorption bands are very wide. As an example, Cr:ZnSe absorbs light in an approximately 500 nm wide band from ˜1500 nm to ˜2000 nm, having a peak absorption near 1800 nm. The wide bands mean that the wavelength of the pump source is not critical, which reduces cost and complexity. One exemplary pump laser is a Q-switched solid-state laser, for example one doped with thulium (Tm) ions—a specific example would be a Tm:YALO laser. Use of a pulsed pump laser is advantageous particularly at pulse repetition frequencies (PRFs) lower than the inverse fluorescence lifetime of the Cr²⁺ laser material, which is typically on the order of 1-10 microseconds. In this operational mode the Cr²⁺ laser is gain switched, meaning that the laser inversion builds up rapidly as the result of the pulsed pump producing a pulsed output beam 110. The laser can also be operated in a continuous-wave (CW) mode when pumped by a CW source laser, such as a CW Tm doped fiber laser. When pumped by a CW or pulsed source the laser can also be advantageously Q-switched to produce high peak power energetic laser pulses. To operate the laser in Q-switched mode a suitable Q-switch is inserted into the laser cavity, as is well known in the art. This device may be an acousto-optic Q-switch or it may be an electro-optic Q-switch. A further option is to use a saturable absorber, such as a semiconductor saturable absorber mirror, as a Q-switch. When Q-switched with CW pumping the laser operates most efficiently at PRFs higher than the inverse fluorescence lifetime, such as at PRFs in the range from approximately 100 kHz to greater than 1 MHz. CW pumping is not required to operate the laser in Q-switched mode. It can also advantageously be Q-switched with pulsed pumping, provided that the Q-switching is properly synchronized in time with the pump pulse.

Cr²⁺ lasers may also be operated in other modes, such as cavity-dumped and mode-locked (see for example, T. J. Carrig et al., “Mode-locked Cr²⁺:ZnSe laser”, Optics Letters vol. 25, pp. 168, 2000 hereby incorporated by reference).

### 2. Demonstrated Operation

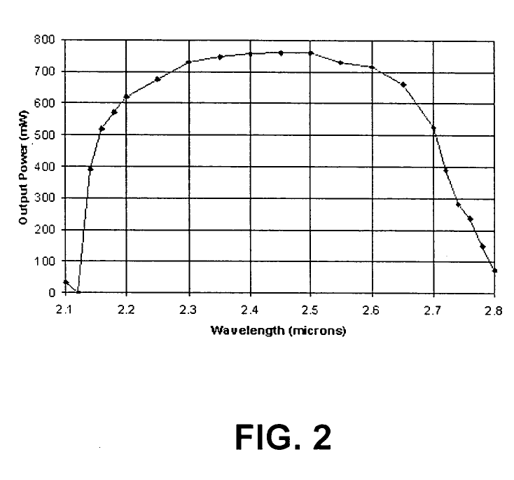

The inventors have built a laser of the essential design illustrated in FIG. 1. In the demonstration laser the pump source was a Q-switched Tm:YALO laser operating at 7 kHz with pulse durations of 150 ns. The pump pulses were used to pump a 10 mm long Cr:ZnSe crystal having a doping concentration of Cr²⁺ ions of approximately 6×10¹⁸ cm⁻³. The cavity contained a model N48045-2.5-2.5 TeO₂ AOTF from NEOS Technologies, Inc. having a diffraction efficiency of >95%. The wavelength was set by sending a control signal, in this case an appropriate 30-bit digital control word, to an RF synthesizer that contains voltage control oscillator (VCO) (not shown). By varying the control signal the wavelength of the laser was tuned from approximately 2100 nm to 2800 nm as illustrated in FIG. 2. The laser gain element itself permits greater tuning, but the total tuning range was in the illustrated case limited by the change in the reflectivity of mirror coatings near the edges of the tuning range. Improved coatings would consequently further improve the tuning range of the laser, such as to greater than 3000 nm at the long wavelength end, as suggested by the spectroscopic data published by Page et al. cited above. The response time of the AOTF as implemented is approximately 10 microseconds. This is a several orders-of-magnitude advance compared with mechanical or thermal tuning devices and illustrates that it is feasible to switch wavelengths on consecutive pulses if the laser is operated at PRFs as high as 100 kHz. Slower tuning is clearly also feasible. The stated switching time is not intrinsic to the AOTF itself but is rather limited by the switching time of the driver electronics. The intrinsic switching time of acousto-optic devices is essentially the transit time of sound through the light beam. The speed of sound in common AO materials is on the order of 5,000 m/s and typical dimensions may be in the range of 1-20 mm, so the transit time limit is on the order of 0.2-4 microseconds, much shorter than in the specific device used in the experiments. An optimized driver and an AOTF with a short interaction length will consequently permit significantly faster tuning, such as wavelength tuning at rates >1 MHz.

### 3. Extended Tuning Range

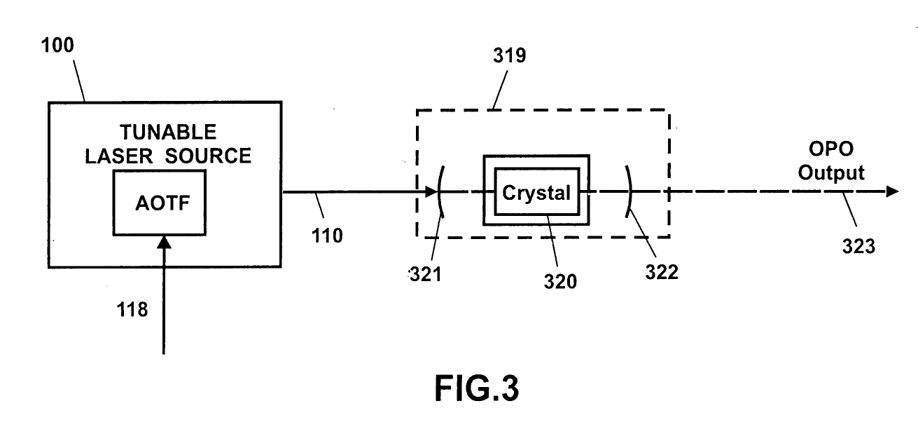

The laser source as described above permits rapid tuning of the source over the general range of 2-3 μm. This is sufficient for a number of applications, but further versatility is achieved by coupling the laser with a frequency conversion device to extend the tuning range to longer wavelengths. While a number of non-linear frequency conversion devices exist that may be advantageously utilized, including those relying on the Raman effect, difference frequency generation, or sum frequency generation, the preferred mode of operating an extended tuning range source is to couple the laser with an optical parametric oscillator (OPO) as illustrated in FIG. 3. The theory of operation of parametric devices is well known in the art and a discussion of IR OPOs can be found in references such as Vodopyanov (K. L. Vodopynov, “Pulsed Mid-IR Optical Parametric Oscillators” in Solid-State Mid-Infrared Laser Sources, ed. By I. T. Sorokina and K. L. Vodopynov, vol. 89 in Topics in Applied Physics (Springer, Berlin 2003), hereby incorporated by reference. As a very brief introduction, there are two basic physics requirements of OPOs:

(1) energy must be conserved or

ωₚ=ωₛ+ωᵢ, or 1/λ_{P}=1/λₛ+1/λᵢ and (Eq.1)

(2) momentum must be conserved or

kₚ=kₛ+kᵢ or nₚ/λₚ=nₛ/λₛ+nᵢ/λᵢ (Eq.2)

where ω, k, and n are the frequency, wave vector, and index of refraction at the pump, signal, and idler wavelengths. The latter requirement is referred to as phasematching. The OPO is designed to produce a specific pair of signal and idler wavelengths with, by convention, the idler generally denoting the longer OPO output wavelength.

As shown in FIG. 3, an OPO 319 generally comprises a non-linear crystal 320 placed between resonator mirrors 321 and 322. Materials suitable for a Cr²⁺ laser pumped OPO include, but are not limited to, ZnGeP₂ and CdSe using birefringent phase-matching and orientation patterned GaAs and ZnSe that employ quasi-phase-matching. The mirrors may be coatings applied directly to the ends of a suitably shaped crystal, rather than one or more physically separated mirrors. Pumping with the tunable laser source 100 output beam 110 causes the OPO to convert the laser beam to two secondary beams, the signal and idler. The result is that changing the RF frequency signal 118 (see FIG. 1) tunes the wavelength of laser beam 110, which in turn tunes the output wavelengths of OPO output beam 323. This process of tuning the OPO wavelength with the wavelength of laser beam 110 is referred to as “pump-tuning” and has clear advantages over alternative OPO tuning methods, in particular due to the fact that the OPO can be tuned as rapidly as the tunable laser source 100.

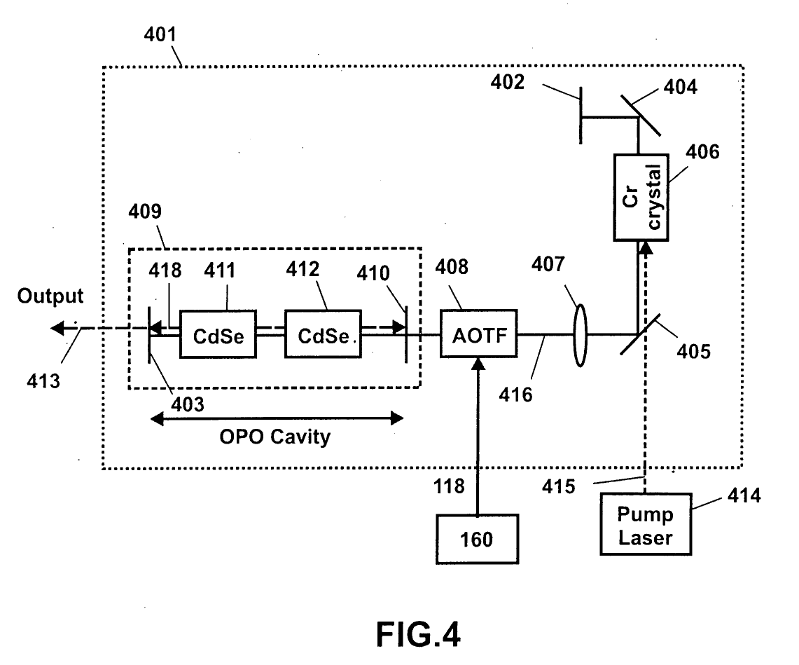

It is not necessary to use the extra-cavity OPO configuration shown in FIG. 3. In many cases it is advantageous to operate the OPO in an intra-cavity configuration to take advantage of the higher laser intensities possible inside the laser cavity. Such a configuration is illustrated in FIG. 4. The transmitter 401 architecture shown in FIG. 4 is similar to the laser configuration in FIG. 1 with the exception that an OPO has been added to the laser cavity. As discussed with respect to FIG. 1 above a pump laser 414 outputs pump laser beam 415 which is transmitted through optic 405 and is absorbed in Cr²⁺ laser crystal 406. Optic 405 is designed such that it is highly transmissive at the pump wavelength while having a high reflectivity at the laser wavelength. The Cr²⁺ laser cavity is terminated at one end by highly reflecting (at the laser wavelength) mirror 402, and at the other end by reflective optic 403 which is also highly reflective at the laser wavelength. Optics 404 and 405 are both highly reflective at the laser wavelength. Lens 407 is designed to produce a suitable mode size of the laser beam, while AOTF 408 is used as above to tune the laser cavity.

Internally to the laser cavity terminated by mirrors 402 and 403 is placed an OPO cavity 409 terminated by mirrors 403 and 410. Mirror 403 is designed to be highly reflective at the laser wavelength and to be partially transmissive at at least one OPO wavelength which is desired as OPO output. Mirror 410 is designed to be highly transmissive at the laser wavelength but to be highly reflective at the desired OPO output wavelength. Mirrors 403 and 410 may be transmissive, reflective or partially reflective at the other OPO wavelength depending on whether one or both OPO wavelengths are desired as usable output. Inside OPO cavity 409 is placed one or more non-linear crystals, for example CdSe crystals, 411 and 412. In principle only one crystal is needed but it is sometimes desired to use more than one, for example for walk-off compensation.

Operation of the transmitter is as follows: pump laser 414 pumps laser crystal 406 to produce a population inversion. This creates a laser beam 416 that circulates within the laser cavity defined by mirrors 402 and 403. The wavelength of laser beam 416 is controlled by AOTF 408, which is in turn controlled through input RF electrical signal 118 derived from tuning control subsystem 160. Through parametric frequency conversion OPO crystals 411 and 412 convert part of the circulating light beam 416 into an OPO beam that circulates between mirrors 410 and 403. Part of this circulating OPO beam is transmitted through mirror 403 and becomes output beam 413.

The important and novel feature of the architecture illustrated in FIG. 4 is that the frequency of the output beam 413 is determined by the frequency of the circulating laser beam 416. Since the laser beam frequency is in turn tuned via input signal 118, the output frequency of beam 413 is directly determined by electrical control signal 118. As noted above this method of tuning the OPO can be extremely fast.

As noted in the introduction one benefit of using an OPO or other frequency converter is that many chemical vapors of interest have absorption features in the mid and long wave infrared (MWIR and LWIR) spectral ranges covering approximately 2 to 14 μm. Chemicals of interest include as examples: chemical warfare agents, such as mustard gas, VX, sarin, and tabun; hydrocarbons, such as methane and ethane, and toxic industrial chemicals, such as benzene. Having laser sources, particularly tunable sources, available provides for a convenient method of probing for specific chemical vapors or materials. The electrical tunability of the disclosed devices provides not only the benefit of tuning, but unlike other tuning devices that are based on mechanical movements, the electrical tunability is also very fast and precise. Therefore rapid and arbitrary switching between probing wavelengths is possible. The source as disclosed may also be useful as a transmitter for a number of IRCM applications since the wavelength can be altered to optimize the source to defeat different types of missile seekers or to potentially defeat counter countermeasures such as narrowband filters.

When frequency converters are used it is not necessary to completely convert the laser output to a second wavelength. In many instances it may be desirable to perform a partial conversion so that light at the pump wavelength is also available, as may be the case for probing two discrete vapor absorption lines or for performing multi-band reflectivity measurements on hard targets using a laser-based remote sensing system. In the case of using an OPO three wavelengths can easily be generated (pump, signal, and idler) for such use. Any number of other possibilities are also apparent, such as using multiple OPOs for generation of a plurality of tunable or fixed wavelengths.

### 4. Alternative Embodiments

A number of alternative embodiments and alterations can easily be made to the disclosed source. Certain applications, such as coherent laser radar and DIAL detection of chemical vapors with narrow absorption bands, benefit from laser operation with a highly defined frequency. In the case of infrared DIAL applications, for example, it is frequently desired that the laser spectral linewidth be narrower than a few GHz. One possibility is to injection-seed the laser at one or more wavelengths in succession so that specific and narrow wavelengths are generated in succession. This wavelength and bandwidth control may be achievable by injection-seeding the laser with a second stable laser (“Master Oscillator”) that produces the appropriate frequency. This may be done for example using a single-frequency diode laser or other suitable devices as the injection-seeder. One alternative seeding device is another fixed-frequency or tunable single-frequency Cr:ZnSe laser. Numerous methods are known in the art for injection-seeding, including injection of the seed light through a cavity mirror or through an intra-cavity Q-switch.

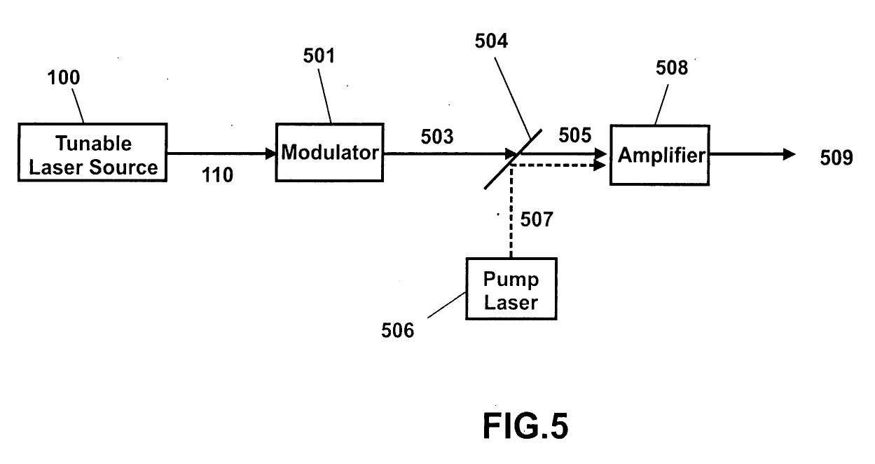

The term “Master Oscillator” or MO is generally used to designate a laser whose frequency determines the frequency of an auxiliary laser or amplifier. One example was given above. A second configuration where the term is used is in Master Oscillator Power Amplifier (“MOPA”) configurations where an optical signal from a master oscillator is used with an amplifier that increases the optical output power, in order to produce a higher power beam. An exemplary MOPA configuration is illustrated in FIG. 5, where a Master Oscillator (tunable laser source 100) produces a beam 110, which is directed through an optional modulator 501 to produce beam 503, and further through dichroic optic 504 as beam 505 toward amplifier crystal 508. Simultaneously pump laser 506 produces a pump laser beam 507 that reflects from dichroic 504 and enters amplifier 508 co-aligned with beam 505. Pump beam 507 is absorbed and produces a population inversion in crystal 508, thus producing optical gain in crystal 508 that amplifies beam 505. As a result output beam 509 has higher power than input beam 505. The master oscillator may be a low power tunable diode laser or it may be a Cr²⁺ laser such as the one illustrated in FIG. 1. The purpose of optional modulator 501, when it is present, is to modulate a characteristic of laser beam 110. It may, for example, be used to modulate the amplitude (amplitude modulator) or frequency (phase modulator) of beam 110.

A second alternative embodiment replaces the tuning element 106 with a device that produces narrower output linewidths. The observed linewidth in the constructed laser was approximately 0.5-0.7 nm (approximately 24-34 GHz at 2.5 μm), which is sufficient for many applications, but often insufficient for applications like DIAL that probe individual chemical vapor absorption lines and may require a linewidth in the 0.1 -1 GHz range. Operation of the invention is not dependent on a particular choice of tuning device, but as an example one or more tunable electro-optic Lyot filters may be used to reduce linewidths while permitting very rapid tuning. In the case of electro-optic Lyot filters, electro-optic modulators (EOM's) and polarizers are used to create a narrow spectral band pass that can be tuned by varying the bias voltage on the EOM's. The use of multiple Lyot filters can enable simultaneous course and fine tuning.

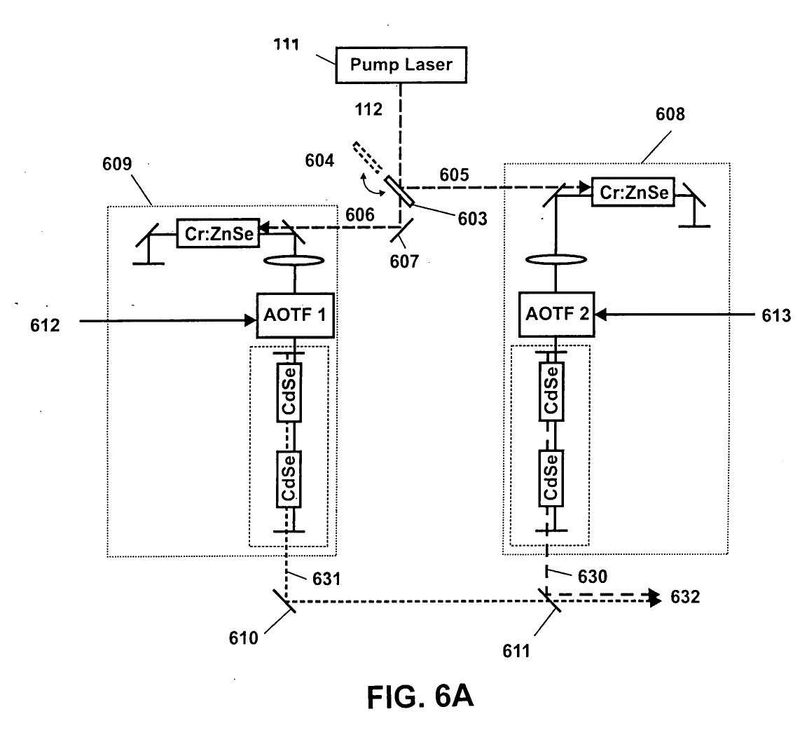

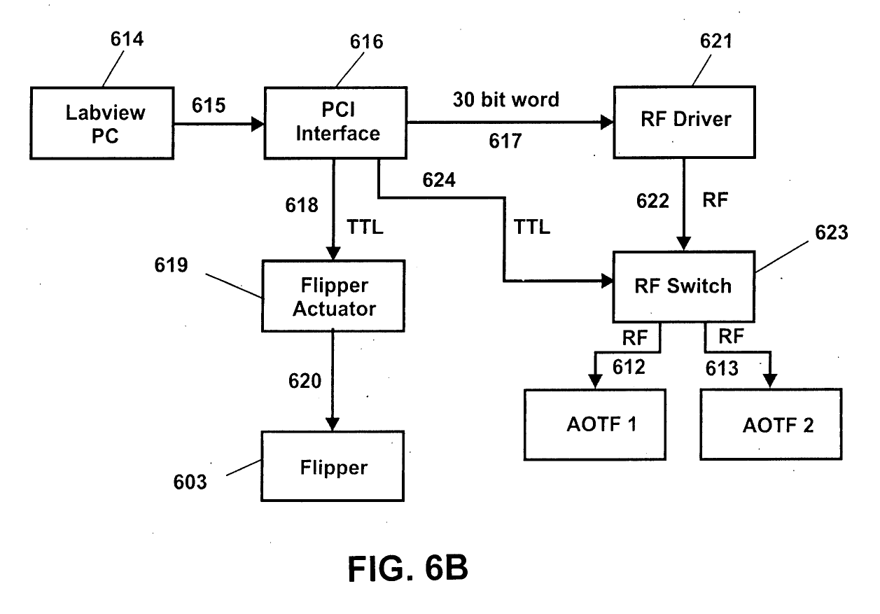

While OPO crystals have the demonstrated potential to produce tunable output over extended wavelength ranges, for a given range of pump wavelengths the range of output wavelengths is nevertheless sometimes insufficient to cover a desired spectral range. In such cases it is possible to extend the wavelength range by operating two or more OPOs in a parallel configuration as illustrated in FIG. 6. In FIG. 6A a pump laser 111 produces a pump beam 112 that is incident on a “flipper” mirror 603 that can be moved to a second position 604 where it does not intercept laser beam 112. In the illustrated position mirror 603 redirects beam 112 as beam 605 into a tunable source 608 that is functionally equivalent to system 401 in FIG. 4. Tuning signal 613 is used to tune the OPO over a predetermined wavelength range λ₁-λ₂ which is output as beam 630. When the flipper mirror 603 is moved to the alternative location 604 pump beam 112 reflects from mirror 607 and is directed into a second tunable source 609. This second source is tuned via a tuning signal 612 to output a beam 631 with a wavelength in a range λ₃-λ₄. Beam 631 is redirected via mirror 610 and is incident on optic 611, as is beam 630. Optic 611 is designed to be dichroic such that it is highly reflective for wavelengths in the range λ₁-λ₂, while being highly transmissive in the wavelength range λ₃-λ₄. Since mirror 603 is at any given time in one of two positions the output beam 632 will have a wavelength either in the range λ₁-λ₂ or in the range λ₃-λ₄. FIG. 6B shows a control electronics configuration suitable for operating the described dual tunable OPO system. A PC 614 operating a suitable software program, such as LabVIEW®, sends control signals 615 through a computer interface 616, such as a PCI interface. The interface 616 outputs multiple signals as follows. A TTL signal 618 is sent to a flipper mirror actuator, which in turn controls the position of flipper mirror 603 through signal 620, thereby positioning flipper mirror 603 in one of two locations. Interface 616 also outputs a 30 bit word 617 to direct one of the two tuning elements, AOTF 1 or AOTF 2, via signals 612 or 613 to tune the appropriate OPO to a specified wavelength. Signal 617 is received by RF driver 621 which outputs an RF signal 622 at the appropriate RF frequency to RF switch 623. RF switch 623 directs RF signal 622 to AOTF 1 as signal 612 or to AOTF 2 as signal 613 depending upon the setting of a TTL level control signal 624. The control signal 624 is synchronized with TTL signal 618 such that when signal 618 directs flipper actuator 619 to position mirror 603 as shown in FIG. 6A then signal 624 directs RF switch 623 to output RF power as signal 612. When signal 618 directs actuator 619 to move mirror 603 to alternate location 604 in FIG. 6A, signal 624 directs RF switch 623 to output RF power as signal 613. In this description it has been assumed that mirror 603 is a “flipper” mirror that can be moved between positions through e.g. electromechanical means. This is a relatively slow process but may suffice for certain applications. When rapid switching is required the switch may be replaced by a faster device, such as an electro-optic switch. It is also stressed that operation of the invention in the described manner is not dependent upon specific computers, software, interfaces, or control signal formats or levels. Terms such as PC, Labview, PCI, TTL, 30 bit word, have therefore been included only as specific examples. When the system is operated in this manner different tuning ranges λ₁-λ₂ and λ₃-λ₄ for the two OPOs may be achieved by using two different materials for the OPOs, or it may be achieved by using the same material with a different orientation of the crystals to achieve phase-matching over different wavelength ranges. It is also possible to cascade OPOs in a series, also referred to as tandem, configuration. In such a case the tunable laser source 100 is used to pump-tune an OPO as shown in FIG. 3, with the addition of a second OPO that is pumped and pump-tuned by the first OPO. Thus the second OPO is indirectly pump-tuned by the tunable laser source 100.

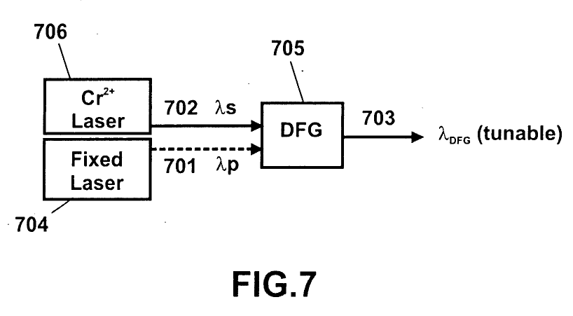

There are a number of additional variations to the described device that can be used to extend the tuning range of the laser. For instance an optical parametric generator (OPG) can be used. The OPG operates like an OPO but without a resonant cavity. In this case the device would look similar to the laser pumped OPO shown in FIG. 3 with the exception that mirrors 321 and 322 are not needed. The advantage of the OPG is simplicity. A disadvantage is that the wavelength conversion efficiency is generally much lower than with an OPO. Similarly the wavelength conversion could be accomplished using a Raman material. In this case the Raman material could be placed in a resonator in a similar manner as the OPO crystal 320 that is shown in FIG. 3 or used without a resonator as with the OPG. In the case of Raman conversion the output of the nonlinear conversion stage would consist of only one frequency converted wavelength (unlike an OPO which has both signal and idler beam outputs) plus any residual unconverted pump. It is also possible to cascade Raman conversion processes so that the first Raman stage output is used to pump a second Raman conversion stage. In this case the second conversion step can take place in the same material responsible for the original Raman conversion or in a separate, second, Raman conversion material. The tunable laser can also be combined with a difference frequency generator (DFG) or a sum frequency generator (SFG) rather than an OPO. Like OPOs and OPGs, DFGs and SFGs are both parametric conversion devices. The case of a laser pump-tuned DFG is shown in FIG. 7. In this case a DFG 705 is pumped with fixed laser input 701 a at wavelength λₚ from laser 704 and seeded with tunable laser input 702 at wavelength λₛ from Cr²⁺ laser 706. The DFG then produces tunable output 703 at wavelength λ_{DFG}. λₛ can be at a wavelength longer or shorter than λₚ, however λ_{DFG} will always be at a wavelength longer than both λₛ and λₚ. The DFG must satisfy basic physics requirements similar to OPOs, specifically,

(1) energy must be conserved or

ωₚ−ωₛ=ω_{DFG}, or 1/λₚ−1/λₛ=1/λ_{DFG} and (Eq.3)

(2) momentum must be conserved or

kₚ−kₛ=k_{DFG} or nₚ/λₚ−nₛ/λₛ=n_{DFG}/λ_{DFG} (Eq.4)

where ω, k, and n have the same meanings as in equations 1 and 2. As mentioned above, it is also possible that the seed wavelength is at a higher frequency than the pump wavelength so the DFG can also operate according to the following physics equations,

(1) energy must be conserved or

ωₛ−ωₚ=ω_{DFG}, or 1/λₛ−1/λₚ=1/λ_{DFG} and (Eq. 5)

(2) momentum must be conserved or

kₛ−kₚ=k_{DFG} or nₛ/λₛ−nₚ/λₚ=n_{DFG}/λ_{DFG} (Eq.6)

The SFG is analogous but the tunable output, λ_{SFG}, is at a frequency that is the sum of the pump and seed frequencies or

ωₛ+ωₚ=ω_{SFG}, or 1/λₛ+1/λₚ=1/λ_{SFG} (Eq.7)

In this case phasematching must also occur. An SFG would be configured the same as the DFG shown in FIG. 7 except that the output would be at a frequency that is the sum of the input frequencies rather than the difference. Materials used for OPGs, DFGs and SFGs are similar to those used for OPOs with the same basic requirements and are well known in the art. Raman conversion materials are also well known in the art.

The electrical means to tune the laser has been described in terms of digital devices, including computers and software. The manner of tuning an RF signal for application to the AOTF is not important in operating the invention. It is for example possible to use analog devices, including voltage controlled oscillators (VCO) for such purposes. When a VCO is used the output RF frequency used to drive the AOTF is substantially proportional to an input voltage to the VCO.

In the preceding, reference has been made specifically to Cr²⁺ doped ZnSe, but the invention is not restricted to use this material or specifically a crystalline host material. Any Cr²⁺ doped laser-active material can be used, including alternative crystals like ZnS, as well as other types of materials, including polycrystalline host materials which are also sometimes referred to as ceramics.

Operation of the invention is not reliant on a specific material for the OPO. Selection of the material is determined by several factors, including efficiency and wavelength coverage. Examples of suitable materials include, but are not limited to: ZnGeP₂, CdSe, orientation patterned GaAs (“OPGaAs”), and orientation patterned ZnSe (“OPZnSe”). One key parameter in selecting a nonlinear crystal is whether the crystal is optically transparent at the desired operating wavelengths. The selection of a nonlinear crystal is also dependent on the change in the material's refractive indices as a function of wavelength, which will determine how the signal and idler wavelengths tune as the OPO pump wavelength is tuned. When pump-tuned by a 2-3 μm Cr:ZnSe laser, CdSe, ZnGeP₂ and OPGaAs, for example, offer very good tuning and high transparency in the 3-5 μm mid-wave infrared (MWIR) spectral region. Similarly, CdSe and OPGaAs tune very well and are highly transparent in the 8-12 μm long-wave infrared (LWIR) spectrum. These are but a few examples of nonlinear crystals and wavelength regions of interest. There are many other types of nonlinear crystals that can be employed in these and other spectral regions.

The laser source as disclosed can clearly incorporate amplifiers to boost the power or pulse energy of the laser. Alternately optical parametric amplifiers (OPA) that amplify the OPO output could also be used.

A highly attractive option for pumping the Cr²⁺ laser is to use semiconductor diode lasers. These can be constructed with high efficiency and, since the absorption bands of the Cr²⁺ material are wide, there is typically not a need to actively control the emission wavelength of such pump sources, as is frequently the case when pumping other solid-state crystalline lasers.

The form of the laser crystal and operating principle of the laser is not critical to implementation of the disclosed invention. In many cases the laser will be operated in a conventional rod geometry, but the use of the laser in disk, slab, microchip, or waveguide form is also possible.

The benefits of the present invention enable a number of applications that include, but are not limited to use as a general purpose tunable wavelength source, or use as the transmitter in a remote sensing lidar system. Specific uses of such a remote sensor include, but are not limited to: remote detection of chemical vapors and aerosols, mapping distributions of airborne dispersed materials, early warning of unintentional or intentional release of chemical and/or biological agents, active multi-spectral sensing, and hybrid active/passive hyper-spectral sensing. Additionally the invention can be used for certain directed energy applications such as IRCM. Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention.

What is claimed is:

1. A rapidly electronically tunable laser source, comprising:
a laser medium comprising a host material doped with Cr²⁺ ions;
a pump source to produce a population inversion in the laser medium;
a laser cavity to produce a laser beam by extraction of the population inversion into a first output beam having a first wavelength; and
an electrically variable tuning element located within the laser cavity to alter the first wavelength of the first output beam
wherein the tuning element alters the first wavelength in response to an electrical input signal.

2. The tunable laser source of claim 1 wherein the host material is a crystalline material.

3. The tunable laser source of claim 2 wherein the host material is selected from the group consisting of ZnSe; ZnS; CdSe; ZnTe; ZnSₓSe₁₋ₓ and CdMnₓTeₓ₋₁.

4. The tunable laser source of claim 1 wherein the host material is selected from the group consisting of: single crystal; polycrystalline; and ceramic.

5. The tunable laser source of claim 1 wherein the pump source is a laser.

6. The tunable laser source of claim 1 wherein the pump source is a fiber laser.

7. The tunable laser source of claim 1 wherein the pump source is a semiconductor diode laser.

8. The tunable laser source of claim 1 wherein the pump source is a diode-pumped solid-state laser.

9. The tunable laser source of claim 1 wherein the pump source is a Tm laser.

10. The tunable laser source of claim 1 wherein the pump source is a pulsed laser.

11. The tunable laser source of claim 1 wherein the pump source is a continuous-wave laser.

12. The tunable laser source of claim 1 wherein the first tuning element is an acousto-optic device.

13. The tunable laser source of claim 12 wherein the acousto-optic device is an acousto-optic tunable filter (“AOTF”).

14. The tunable laser source of claim 1 wherein the first tuning element is an electro-optic device.

15. The tunable laser source of claim 14 wherein the electro-optic device is a Lyot filter.

16. The tunable laser source of claim 1 wherein the first tuning element is a liquid crystal device.

17. The tunable laser source of claim 1, further comprising:
a nonlinear optical frequency conversion device (“frequency converter”) to accept the first output beam at the first wavelength and convert it into a second output beam at a second wavelength.

18. The tunable laser source of claim 17 wherein the frequency converter uses the Raman effect.

19. The tunable laser source of claim 17 wherein the frequency converter is an optical parametric oscillator (“OPO”).

20. The tunable laser source of claim 19 wherein the OPO converts the first output beam at the first wavelength into a second output beam at a second wavelength (“signal”) and a third output beam at a third wavelength (“idler”).

21. The tunable laser source of claim 19 wherein the OPO comprises one from the group consisting of: ZnGeP₂, CdSe, AgGaSe₂, AgGaS₂, orientation patterned GaAs (“OPGaAs”), and orientation patterned ZnSe (“OPZnSe”).

22. The tunable laser source of claim 17 wherein the frequency converter is an optical parametric generator (“OPG”).

23. The tunable laser source of claim 1, further comprising:
a nonlinear optical frequency conversion device (“frequency converter”) to accept the first output beam at the first wavelength, combine it with a second beam at a second wavelength, and convert it into a third beam at a third wavelength.

24. The tunable laser source of claim 23 wherein the frequency converter uses difference-frequency generation.

25. The tunable laser source of claim 23 wherein the frequency converter uses sum-frequency generation.

26. The tunable laser source of claim 23, wherein the second wavelength is altered by altering the electrical input signal.

27. A method of producing laser radiation with a variable wavelength in the infrared spectral range comprising the steps of:
pumping a Cr²⁺ laser having a laser cavity, with a pump source; and
providing an electrical input signal to an electrically variable tuning element inside the laser cavity to effect a change in the laser wavelength.

28. The method of claim 27 comprising the further step of wavelength conversion in a non-linear optical frequency conversion device (“frequency converter”), whereby the output wavelength from the frequency converter is responsive to alterations in the electrically variable tuning element.
